(19) United States
(12) Patent Application Publication
(10) Pub. No.: US 2009/0201553 A1
(43) Pub. Date: Aug. 13, 2009

(54) IMAGE FORMING APPARATUS AND IMAGE FORMING METHOD

(75) Inventor: Keiko Kanamori, Numazu-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/030,357

(22) Filed: Feb. 13, 2008

(51) Int. Cl. G06F 3/12

(52) U.S. Cl. 358/1.16; 358/1.15

(57) ABSTRACT

An image forming apparatus of the invention includes a read unit to read an image and to generate temporal image data from the image, a capacity specifying unit to specify a specified capacity for final image data, and a generation condition setting unit to set a generation condition for generating the final image data from the temporal image data, the final image data not exceeding the specified capacity is generated, and the capacity of the generated final image data is displayed.

### BACKGROUND OF THE INVENTION

1. Field of the Invention

The present invention relates to an image forming apparatus and an image forming method which displays the capacity of image data generated under desired generation conditions from a read image.

2. Description of the Related Art

A recent image forming apparatus is provided with a copy function to copy (reproduce), for example, an image formed on one recording medium to the other recording medium, a scanner function to read an image formed on a recording medium and to generate image data from the read image, a print function to print an image to a recording medium, a FAX function to transmit image data, and the like. Besides, such an image forming apparatus is provided with a mail transmission function or the like. In the mail transmission function, image data or the like is attached to, for example, an electronic mail and is sent.

In general, for example, when image data is attached to an electronic mail and this electronic mail is sent, an upper limit value is set. This upper limit value is, for example, the receivable capacity of the receiving side of the electronic mail or the capacity of the image data which can be attached to the electronic mail. In the case where the image data exceeding the upper limit value is attached to the electronic mail, the image data is divided into plural parts and is transmitted.

For example, JP-A-2004-088613 discloses a scan mail transmission apparatus and a scan mail transmission system in which image data is divided so that an electronic mail can be transmitted without fail.

Besides, when image data is generated by the scanner function, the capacity of the image data is influenced by previously set generation conditions such as resolution. Thus, there is a case where the capacity of the image data becomes larger than a desired capacity. Besides, there is a case where the capacity of the image data exceeds the upper limit value. In these cases, conditions such as resolution are changed, the recording medium is read each time, and the image data having the desired capacity is generated each time.

### BRIEF SUMMARY OF THE INVENTION

It is therefore an object of the present invention to provide an image forming apparatus and an image forming method in which final image data having a capacity not exceeding a specified capacity can be generated, and even if the final image data having the capacity exceeding the specified capacity is generated, it is possible to save the trouble of reading an image each time.

According to an aspect of the invention, an image forming apparatus includes a read unit configured to read an image formed on a recording medium and to generate image data from the image, a first memory unit configured to temporarily store the image data, a capacity specifying unit configured to specify a capacity for final image data finally generated from the image data, a generation condition setting unit configured to set a generation condition for generating the final image data, an image processing unit configured to perform an image processing on the image data and to generate the final image data from the image data based on the generation condition, a second memory unit configured to temporarily store the final image data generated by the image processing unit, and a capacity display unit configured to display capacity of the final image data temporarily stored in the second memory unit.

Besides, according to another aspect of the invention, an image forming method includes reading an image formed on a recording medium, generating image data from the image, storing the image data temporarily, specifying a capacity for final image data finally generated from the image data, setting a generation condition for generating the final image data, performing an image processing on the image data, generating the final image data from the image data based on the generation condition, storing the generated final image data temporarily, and displaying capacity of the temporarily stored final image data.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an outer appearance view of an image forming apparatus.

FIG. 2 is a block diagram schematically showing functions of the image forming apparatus and a connection relation of the image forming apparatus and a PC.

FIG. 3 is a view showing an example of an initial screen displayed on an operation display unit.

FIG. 4 is a view showing an example of a capacity specifying and generation condition setting screen.

FIG. 5 is a view showing an example of a detailed condition setting screen.

FIG. 6 is a flowchart for explaining an operation method in which final image data is generated under a desired specified capacity and generation conditions and the final image data is stored.

FIG. 7 is a view showing an example of a capacity specifying and generation condition setting screen on which generation conditions are set by a user.

FIG. 8 is a view showing an example of a capacity specifying and generation condition setting screen to display generation conditions at the time when the final image data not exceeding the specified capacity is generated and the capacity of the final image data.

FIG. 9 is a view showing an example of a capacity specifying and generation condition setting screen when the capacity of the final image data exceeds the specified capacity.

FIG. 10 is a flowchart for explaining an operation method in which final image data is generated by automatic setting and the final image data is stored.

FIG. 11 is a flowchart for explaining an operation method in which final image data is generated by detailed condition setting and the final image data is stored.

FIG. 12 is a view showing an example of a capacity specifying and generation condition setting screen on which detailed conditions are set by the user.

### DETAILED DESCRIPTION OF THE INVENTION

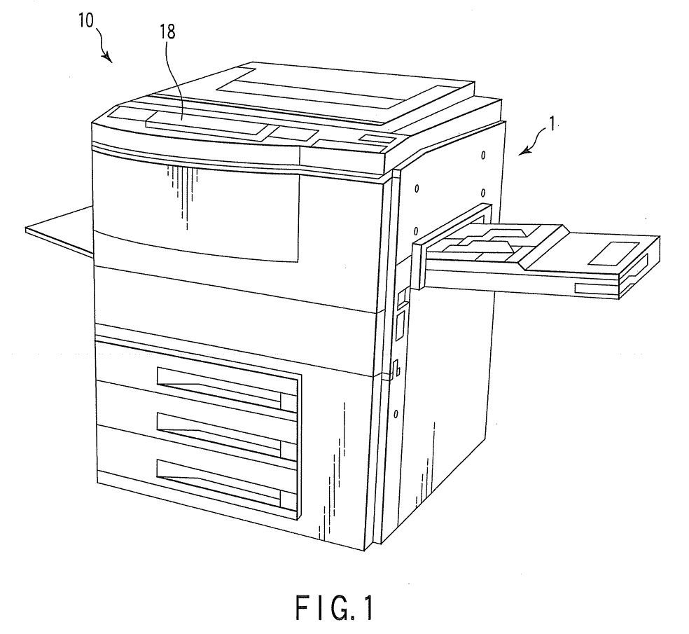

Hereinafter, an embodiment of the invention will be described in detail with reference to FIG. 1 to FIG. 12.

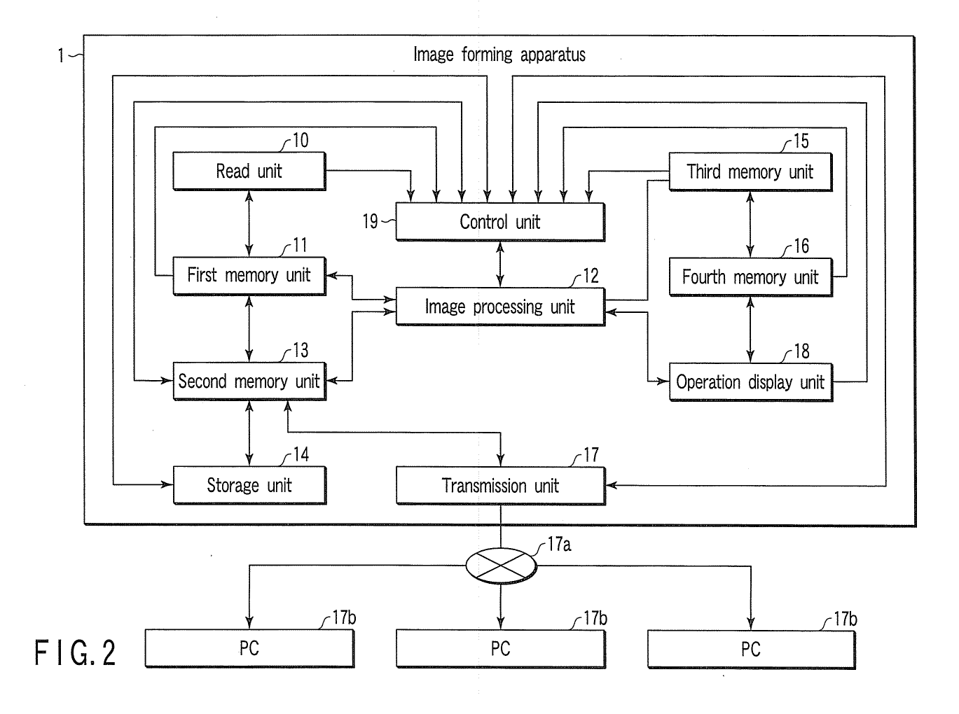

As shown in FIG. 1 and FIG. 2, an image forming apparatus 1 includes a read unit 10, a first memory unit 11, an image processing unit 12, a second memory unit 13, a storage unit 14, a third memory unit 15, a fourth memory unit 16, a transmission unit 17, an operation display unit 18 and a control unit (for example, CPU) 19.

The read unit 10 includes, for example, a scanner having a CCD sensor or the like, and reads an image formed on a recording medium. This image includes, for example, a character, a line drawing, a photograph and the like. The read unit 10 digital converts the read image, and generates electronic data (image data) as an image input signal. Hereinafter, this image data is called temporal image data.

The first memory unit 11 temporarily stores the temporal image data.

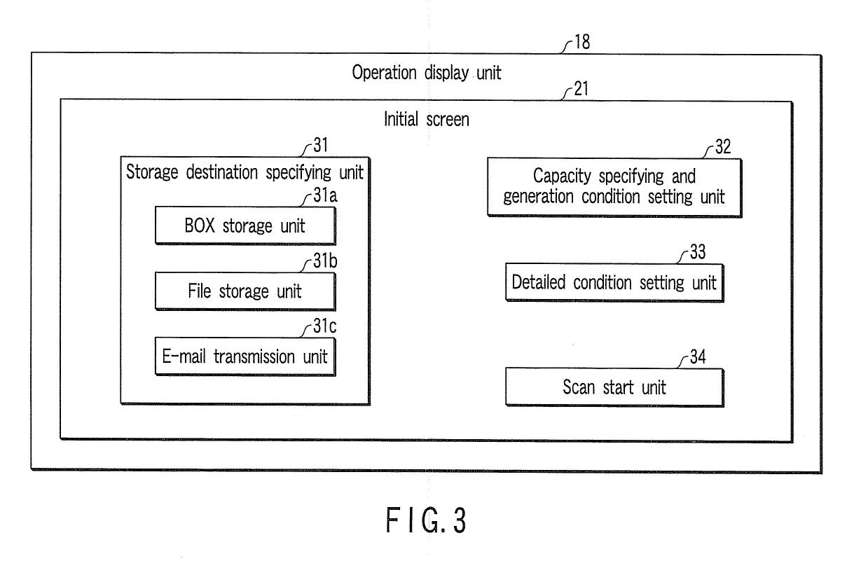

The image processing unit 12 performs an image processing on the temporal image data stored in the first memory unit 11, and generates final image data from the temporal image data. Incidentally, the image processing unit 12 performs the image processing based on a capacity (size, hereinafter referred to as specified capacity) specified, as desired, by the user in an after-described capacity specifying unit 41 shown in FIG. 3 and generation conditions which are set (selected) by the user in an after-described generation condition setting unit 42 shown in FIG. 3. Alternatively, the image processing unit 12 performs the image processing based on detailed conditions which are set (selected) in an after-described detailed condition setting unit 51.

As stated above, the image processing unit 12 performs the image processing on the temporal image data, and generates the final image data from the temporal image data based on the specified capacity and the generation conditions or the detailed conditions. At that time, the image processing unit 12 generates the final image data having the capacity not exceeding the specified capacity specified by the capacity specifying unit 41.

The second memory unit 13 temporarily stores the final image data generated by the image processing unit 12.

The second memory unit 13 and the first memory unit 11 include, for example, RAMs to temporarily store, for example, the temporal image data and the final image data. Incidentally, in this embodiment, although the example is described in which the temporal image data and the final image data are stored in the RAMs, when the temporal image data and the final image data can be rewritten, no limitation is made to the RAM, and for example, a flash ROM or a hard disk can also be used.

The storage unit 14 finally stores the final image data when it is specified as a storage destination by a storage destination specifying unit 31 shown in FIG. 3 and described later. It is sufficient if at least one storage unit 14 is provided. The storage unit 14 includes, for example, a hard disk to store the final image data.

The third memory unit 15 stores, for example, a program previously prescribing an operation procedure of the control unit 19, previously set initial values of generation conditions or detailed conditions, and the like. The third memory unit 15 includes, for example, a ROM.

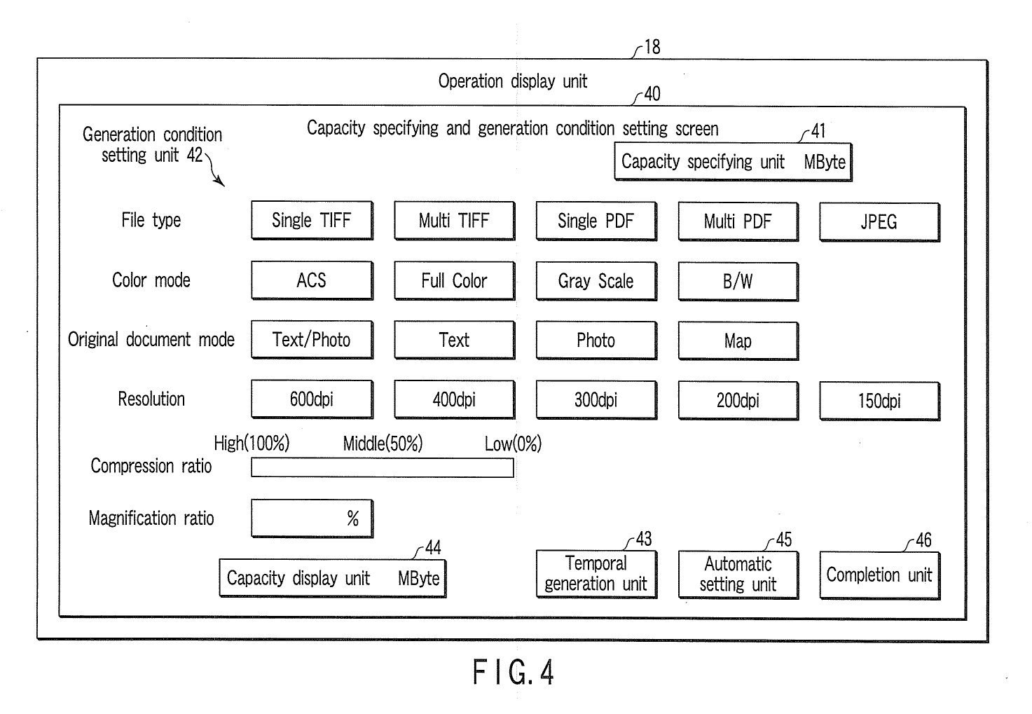

The generation conditions stored in the third memory unit 15 indicate conditions under which the final image data is generated from the temporal image data. The generation conditions include, as shown in FIG. 4, for example, a file type, a color mode, an original document mode, a resolution, a compression ratio, a magnification ratio and the like.

The file type indicates, for example, a format (storage form) of the final image data. The format includes, for example, TIFF, PDF, JPEG and the like. Each of the TIFF and PDF includes a Single mode or a Multi mode.

The color mode indicates, for example, a hue of color (color form) of the final image data. The color form includes, for example, Auto Color Section (hereinafter referred to as ACS), Full Color, Gray Scale, Black/White (hereinafter referred to as B/W) and the like.

When the ACS is selected, the final image data is stored such that a color portion of the image is made color image data, and a monochrome portion of the image is made monochrome image data.

When the Full Color is selected, the final image data is stored as color image data including a color image.

When the Gray Scale is selected, the final image data is stored as monochrome image data including a monochrome image.

When the B/W is selected, the final image data is stored as black and white image data including a black and white image.

The original document mode is a parameter (form) used for generating the final image data. The original document mode includes, for example, Text/Phote, Text, Photo, Map and the like.

The Text/Phote is a form suitable for generation of the final image data from the temporal image data including, for example, a character and a photograph.

The Text is a form suitable for generation of the final image data from the temporal image data including, for example, a character (or a character and a line drawing).

The Photo is a form suitable for generation of the final image data from the temporal image data including, for example, a photograph.

The Map is a form suitable for generation of the final image data from the temporal image data including, for example, a small figure or a small character.

The resolution indicates a scale at the time when the final image data is read from the temporal image data. The resolution includes, for example, 600 dpi, 400 dpi, 300 dpi, 200 dpi, 150 dpi and the like. As the resolution becomes high, clear final image data is generated.

The compression ratio indicates a magnification ratio at the time when the temporal image data is compressed to generate the final image data having a small capacity, and can be adjusted within the range of 0% to 100%. As the compression ratio becomes high, the capacity of the final image data becomes small.

The magnification ratio is a value used when the final image data is generated by expanding or reducing, for example, the temporal image data. When the magnification ratio is 100% or more, the final image data expanded from the temporal image data is generated, and when the magnification ratio is 100% or less, the final image data reduced from the temporal image data is generated.

The fourth memory unit 16 temporarily stores the specified capacity specified, as desired, by the user in the capacity specifying unit 41, the generation conditions which are set (selected) by the user in the generation condition setting unit 42 and the detailed conditions. The fourth memory unit 16 includes a nonvolatile RAM (NV: non-votatile RAM).

The transmission unit 17 is connected to a PC 17b through, for example, a Local Area Network (hereinafter referred to as LAN) 17a. The transmission unit 17 attaches the final image data to, for example, an electronic mail and transmits it to the PC 17b. In this case, the PC 17b is a storage unit specified as a storage destination of the final image data by an E-mail transmission unit 31c in an after-described storage destination specifying unit 31.

The operation display unit 18 is provided with an initial screen 21 (for example, a touch screen) shown in FIG. 3, for performing various operations. The operation display unit 18 displays results of the various operations.

The control unit 19 performs control and operation of the whole system based on the previously prescribed program stored in the third memory unit 15 or instructions from the user. Besides, the control unit 19 is also a calculation unit configured to calculate the capacity of the final image data. The control unit 19 is connected to the read unit 10, the first memory unit 11, the second memory unit 13, the third memory unit 15, the fourth memory unit 16, the image processing unit 12, the storage unit 14, the transmission unit 17 and the operation display unit 18, and controls these.

Next, the initial screen 21 shown in FIG. 3 will be described. The storage destination specifying unit 31 to specify the storage destination of the final image data temporarily stored in the second memory unit 13, a capacity specifying and generation condition setting unit 32, a detailed condition setting unit 33, and a scan start unit 34 are displayed on the initial screen 21. These are selected (touched) when the user performs various operations.

The storage destination specifying unit 31 includes, for example, a BOX storage unit 31a, a File storage unit 31b, and the E-mail transmission unit 31c.

The BOX storage unit 31a specifies the storage unit 14 as the storage destination of the final image data.

The File storage unit 31b specifies, as the storage destination of the final image data, a not-shown storage unit (for example, a hard disk) provided on a not-shown PC connected through a not-shown LAN.

The E-mail transmission unit 31c specifies, as the storage destination of the final image data, a not-shown storage unit (for example, a hard disk) provided on the PC 17b to which the transmission unit 17 can transmit an electronic mail.

The capacity specifying and generation condition setting unit 32 causes an after-described capacity specifying and generation condition setting screen 40 shown in FIG. 4 to be displayed on the operation display unit 18 instead of the initial screen 21.

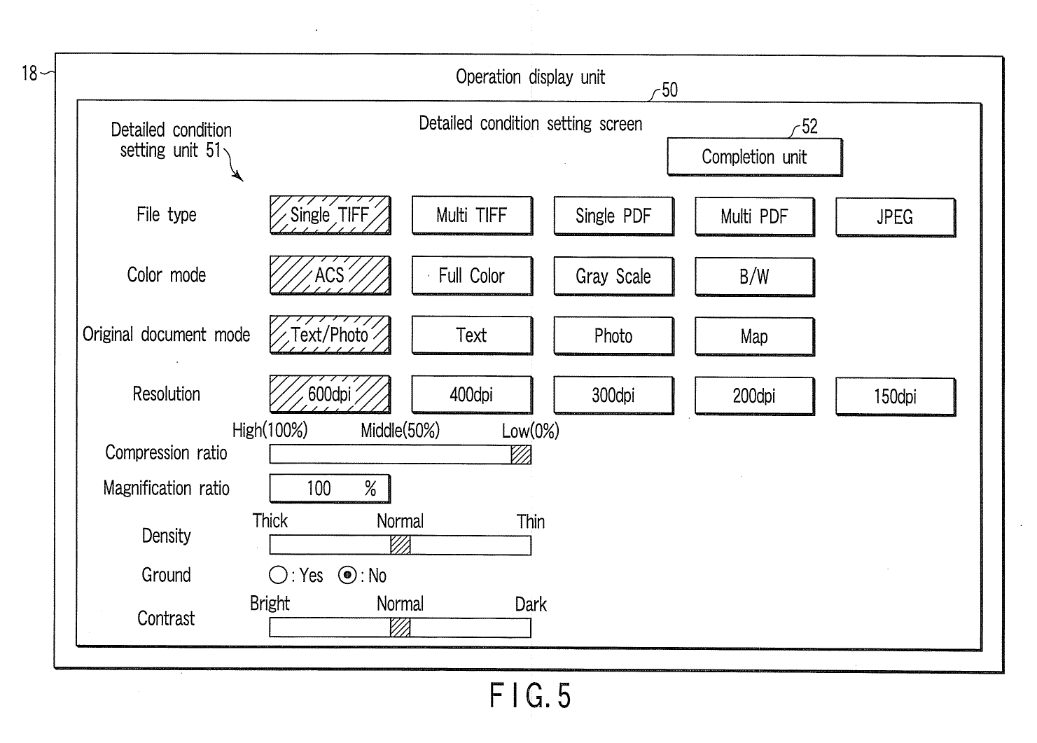

The detailed condition setting unit 33 causes an after-described detailed condition setting screen 50 shown in FIG. 5 to be displayed on the operation display unit 18 instead of the initial screen 21.

When the setting of the detailed conditions which are set in the after-described detailed condition setting screen 50 is completed, the scan start unit 34 causes the final image data to be stored in the storage destination (for example, the storage unit 14) specified by the storage destination specifying unit 31. The final image data is generated based on the detailed conditions from the temporal image data temporarily stored in the first memory unit 11.

Next, the capacity specifying and generation condition setting screen 40 will be described in detail with reference to FIG. 4.

The capacity specifying and generation condition setting screen 40 is a screen (an operation display unit such as, for example, a touch screen) used for specifying the specified capacity for the final image data and for setting the generation conditions.

The capacity specifying unit 41 to specify, for example, the capacity for the final image data, the generation condition setting unit 42 to set the generation conditions for generating the final image data from the temporal image data, a temporal generation unit 43, an automatic setting unit 46, a capacity display unit 44, and a completion unit 45 are displayed on the capacity specifying and generation condition setting screen 40. Various operations are performed by the user and these are selected (touched).

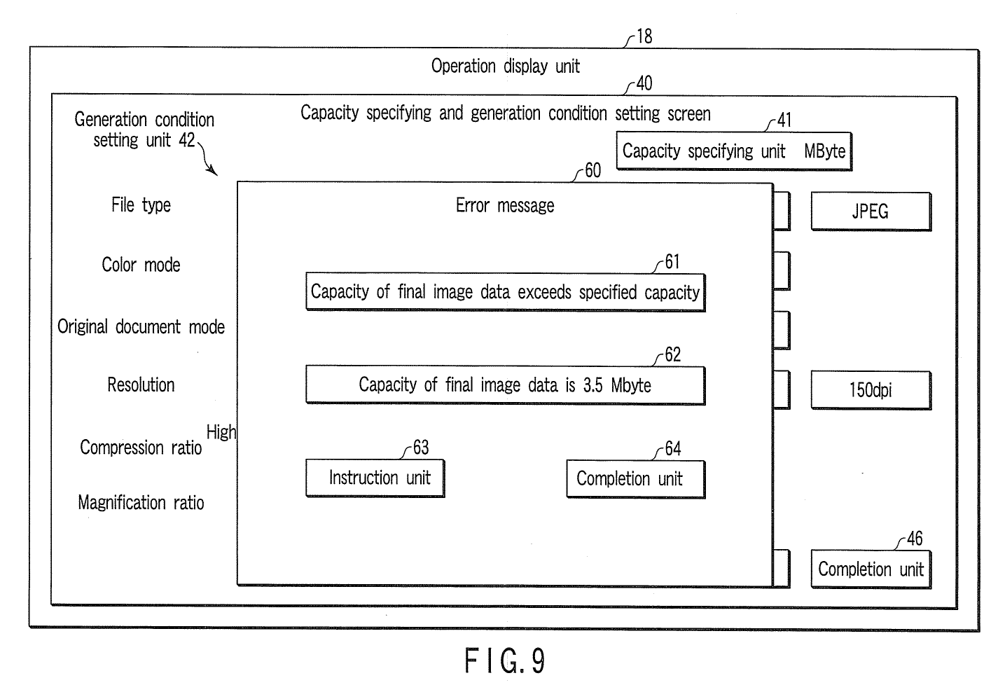

When the capacity of the final image data exceeds the specified capacity, the capacity specifying and generation condition setting screen 40 displays an error message 60 as shown in FIG. 9 described later. The error message 60 includes information 61 to indicate that the capacity of the final image data exceeds the specified capacity, and information 62 to indicate the capacity of the final image data exceeding the specified capacity. As stated above, the capacity specifying and generation condition setting screen 40 is a display unit to display the information 61 and the information 62.

In the generation condition setting unit 42, the generation conditions include, for example, the foregoing file type, the color mode, the original document mode, the resolution, the compression ratio, the magnification ratio and the like. The initial values of the generation conditions are previously stored in the third memory unit 15. As the initial values, here, for example, the initial value of the file type is set to “Single TIFF”, the initial value of the color mode is set to “ACS”, the initial value of the original document mode is set to “Text/Phote”, the initial value of the resolution is set to “200 dpi”, the initial value of the compression ratio is set to “0%”, and the initial value of the magnification ratio is set to “100%”. Incidentally, the set initial values are not previously displayed on the capacity specifying and generation condition setting screen 40 (generation condition setting unit 42) as shown in FIG. 4.

When the final image data is generated, all of these generation conditions may be set by the user. At that time, when the image processing unit 12 generates the final image data based on the generation conditions, the generation condition setting unit 42 serves also as a display unit to display the generation conditions which are set when the final image data is generated.

Besides, when the final image data is generated, none of the generation conditions may be selected. At that time, the image processing unit 12 generates the final image data based on the initial values. Besides, at that time, the generation condition setting unit 42 serves also as a display unit to display the initial values.

Besides, when the final image data is generated, at least only one of the generation conditions may be selected. At that time, the image processing unit 12 generates the final image data based on the generation condition and the initial values. Besides, at that time, the generation condition setting unit 42 serves also as a display unit to display the generation condition which is set when the final image data is generated and the initial values.

The temporal generation unit 43 outputs an instruction to the image processing unit 12 so that the final image data is generated based on the generation conditions which are set by the generation condition setting unit 42.

The automatic setting unit 46 outputs an instruction to the image processing unit 12 so that the generation condition which is not set by the generation condition setting unit 42 is automatically (as desired) adjusted and the final image data does not exceed the specified capacity.

In the generation conditions, for example, when the file type is set to “JPEG” and the color mode is set to “ACS”, the automatic setting unit 46 outputs an instruction to the image processing unit 12 so that the item of the original document mode, and the numerical values of the resolution, the compression ratio and the magnification ratio are adjusted. By this, the image processing unit 12 sets, for example, the original document mode to “Text”, the resolution to “400 dpi”, the compression ratio to “0%”, and the magnification ratio to “0%”, adjusts the combination of the item and the numerical values, and generates the final image data not exceeding the specified capacity.

The capacity display unit 44 displays the capacity of the final image data which is generated by the image processing unit 12 instructed by the temporal generation unit 43 or the automatic setting unit 46, and is temporarily stored in the second memory unit 13.

The completion unit 45 causes the final image data temporarily stored in the second memory unit 13 to be stored in the storage destination (for example, the storage unit 14) specified by the storage destination specifying unit 31. Incidentally, even if the capacity displayed on the capacity display unit 44 is higher than the specified capacity, the completion unit 45 can cause the final image data to be stored in, for example, the storage unit 14.

Next, the detailed condition setting screen 50 will be described in detail with reference to FIG. 5. The detailed condition setting screen 50 is a screen (operation display unit such as, for example, a touch screen) used for setting detailed conditions. For example, the detailed condition setting unit 51 and a completion unit 52 are displayed on the detailed condition setting screen 50.

The detailed condition setting unit 51 sets the detailed conditions for generating the final image data from the temporal image data. The detail condition includes, for example, the foregoing file type, color mode, original document mode, resolution, compression ratio, magnification ratio, density, ground, contrast, and the like. The initial values of the detailed conditions are previously stored in the third memory unit 15, and are previously displayed on the detailed condition setting screen 50 as shown in FIG. 5. Here, for example, the initial value of the file type is set to “Single TIFF”, the initial value of the color mode is set to “ACS”, the initial value of the original document mode is set to “Text/Phote”, the initial value of the resolution is set to “600 dpi”, the initial value of the compression ratio is set to “0%”, the initial value of the magnification ratio is set to “100%”, the initial value of the density is set to “normal”, the initial value of the ground is set to “No”, and the initial value of the contrast is set to “normal”. The detailed conditions are changed as desired in the case where the previously set state is changed. Thus, all of the setting conditions may be changed from the initial state, or none of them may be changed (initial values remain unchanged). Alternatively, at least only one of the setting conditions may be changed.

The completion unit 52 completes the setting of the detailed conditions in the detailed condition setting unit 51. By this, instead of the detailed condition setting screen 50 shown in FIG. 5, the initial screen 21 shown in FIG. 2 is displayed on the operation display unit 18. At that time, when the scan start unit 34 is touched, under the detailed conditions set on the detailed condition setting screen 50, the final image data is stored in, for example, the storage destination specified by the storage destination specifying unit 31. Incidentally, the specified capacity is not specified on the detailed condition setting screen 50.

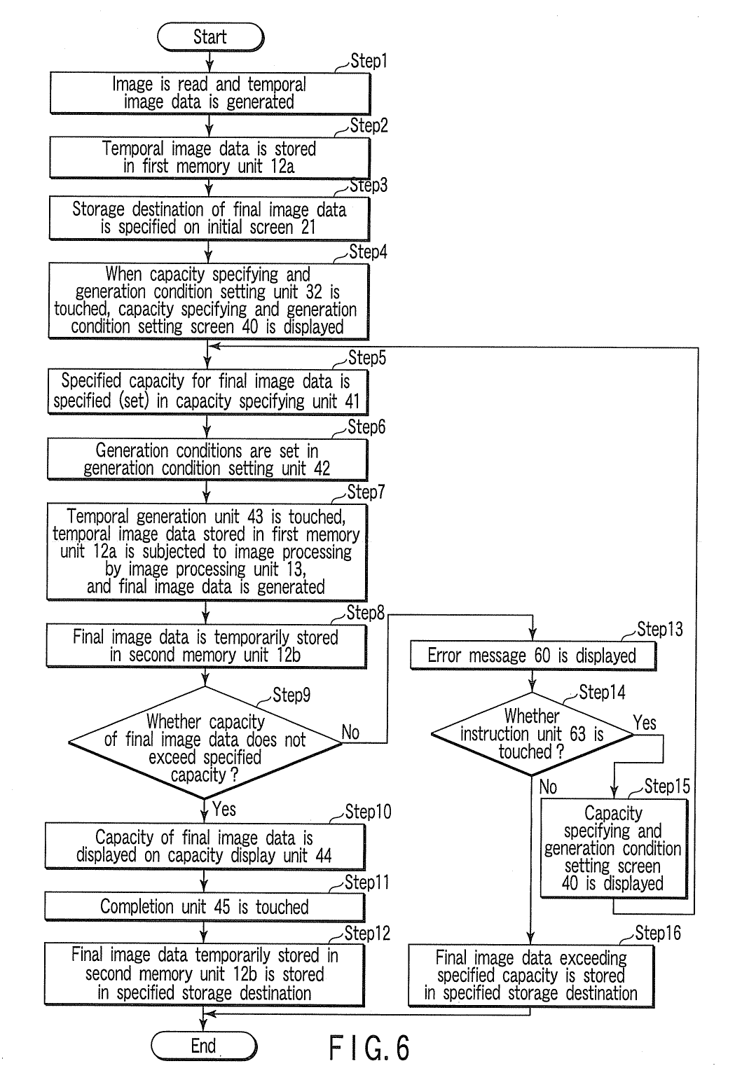

Next, an operation method in this embodiment will be described with reference to FIG. 6.

An image formed on a recording medium is read by the read unit 10, and temporal image data is generated by the read unit 10 based on the read image (Step 1). The temporal image data is temporarily stored in the first memory unit 11 (Step 2).

On the initial screen 21 shown in FIG. 3, the storage destination of the final image data is specified by the storage destination specifying unit 31 (Step 3). At Step 3, for example, when the BOX storage unit 31a is touched by the user, the storage destination of the final image data is specified to the storage unit 14.

When the storage destination of the final image data is specified and the capacity specifying and generation condition setting unit 32 is touched by the user, the capacity specifying and generation condition setting screen 40 shown in FIG. 4 is displayed on the operation display unit 18 (Step 4).

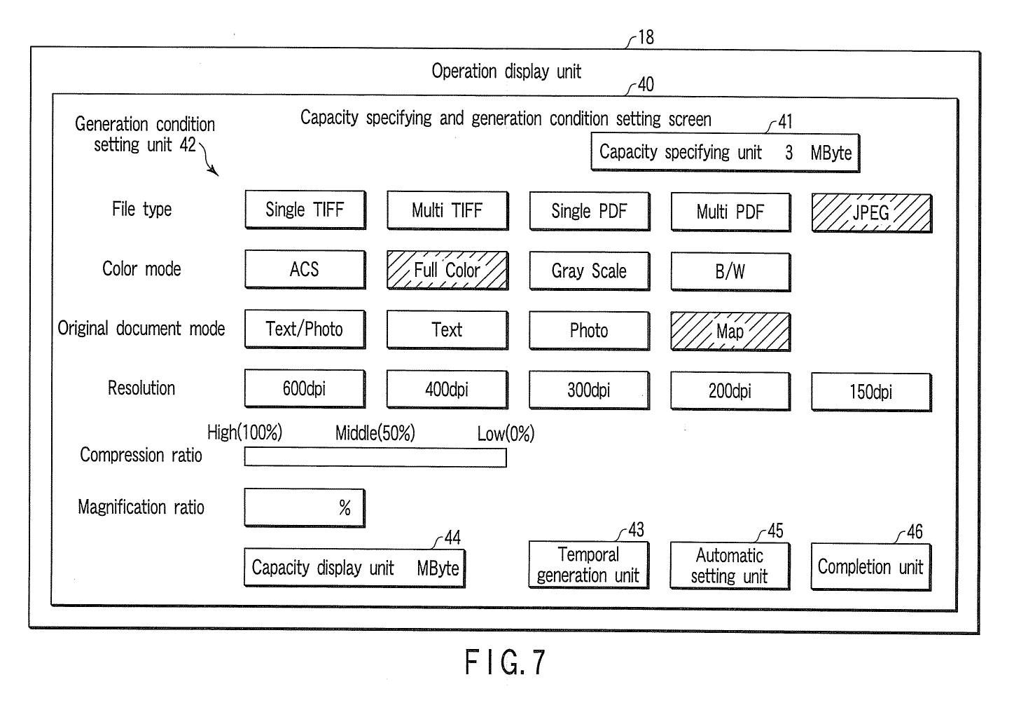

In the capacity specifying and generation condition setting screen 40, the user inputs a numerical value to the capacity specifying unit 41, so that the specified capacity for the final image data is specified (set) as desired (Step 5). As shown in FIG. 7, the specified capacity is specified to, for example, 3 MByte. The specified capacity is temporarily stored in the fourth memory unit 16.

Next, as shown in FIG. 7, the generation condition setting unit 42 is operated by the user, so that the generation conditions are set (Step 6). Incidentally, with respect to the generation conditions, only items desired by the user are set. For example, as shown in FIG. 7, by the user, the file type is set to “JPEG”, the color mode is set to “Full Color”, and the original document mode is set to “Map”. It is assumed that the resolution, the compression ratio, and the magnification ratio are not set by the user. These generation conditions are set when the respective items on the capacity specifying and generation condition setting screen 40 as, for example, the touch screen are touched by the user, and are temporarily stored in the fourth memory unit 16.

As described before, the specified capacity is specified (Step 5), and after the generation conditions are set (Step 6), the temporal generation unit 43 is touched by the user. By this, the temporal image data stored in the first memory unit 11 is subjected to the image processing by the image processing unit 12, and the final image data is generated (Step 7).

At that time, the image processing unit 12 generates the final image data in JPEG, generates the final image data as color image data, and further generates the final image data from the temporal image data including a small figure or a small character (see FIG. 7 and Step 6).

The image processing unit 12 performs the image processing based on, for example, the initial values stored in the third memory unit 15 with respect to the numerical values of the resolution, the compression ratio and the magnification ratio, and generates the final image data. Incidentally, in the above, for example, in the case where the file type is not set by the user, the image processing unit 12 performs the image processing based on the initial value stored in the third memory unit 15 also with respect to the file type, and generates the final image data.

The generated final image data is temporarily stored in the second memory unit 13 (Step 8). The control unit 19 calculates the capacity of the final image data and determines whether the capacity of the final image data does not exceed the specified capacity (Step 9).

For example, in the case where the final image data has a capacity of, for example, 2.8 MByte, the control unit 19 calculates that the capacity is 2.8 MByte, and determines that the capacity of the final image data does not exceed the specified capacity (3 MByte) (Step 9: Yes). At that time, the control unit 19 causes the capacity of the final image data to be displayed on the capacity display unit 44 (Step 10).

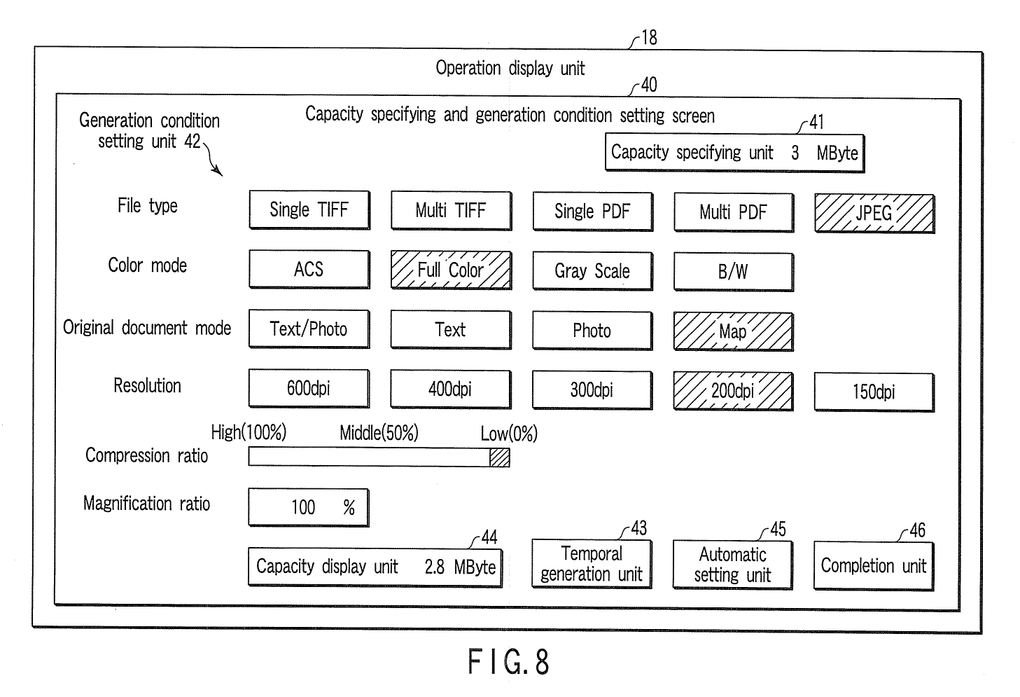

Besides, the control unit 19 causes the capacity specifying and generation condition setting screen 40 (generation condition setting unit 42) to display the contents of setting of the image processing unit 12 with respect to the numerical values and items of the generation conditions which are not set. Here, the generation conditions which are not set are the resolution, the compression ratio and the magnification ratio. The image processing unit 12 uses the initial values for the resolution, the compression ratio and the magnification ratio, and generates the final image data. Thus, for example, as shown in FIG. 8, the generation condition setting unit 42 displays that the resolution is set to “200 dpi”, the compression ratio is set to “0%”, and the magnification ratio is set to “100%”. Besides, the generation condition setting unit 42 displays also the set generation conditions (final type, color mode, original document mode) as shown in FIG. 8.

As stated above, the generation condition setting unit 42 displays the generation conditions and the initial values which are set when the final image data having the capacity not exceeding the specified capacity is generated.

Next, the completion unit 45 is touched by the user (Step 11). By this, the final image data temporarily stored in the second memory unit 12b is stored in the storage destination specified by the storage destination specifying unit 31 at Step 3 (Step 12).

By this, the operation is ended.

Incidentally, between Step 10 and Step 11, although not shown, all items of the generation conditions are set, and when the image processing unit 12 generate the final image data based on the set generation conditions, the generation condition setting unit 42 displays the generation conditions which are set when the final image data is generated. Besides, none of the items of the generation conditions are set, and when the image processing unit 12 generates the final image data based on the initial values, the generation condition setting unit 42 displays the initial values.

Besides, at Steps 7, 8 and 9, for example, even if an item or a numerical value of a generation condition which is not set is set to, for example, an initial value stored in the third memory unit 15, there occurs a fear that the capacity of the final image data exceeds the specified capacity.

For example, in the above, the image processing unit 12 sets, for example, the resolution to “200 dpi”, the compression ratio to “0%”, and the magnification ratio to “100%”. These are items of the generation conditions which are not set by the user at Step 6, and the numerical values of the respective items are initial values. Incidentally, in the case where for example, the file type is not set by the user, the image processing unit 12 performs the image processing based on the initial value stored in the third memory unit 15 also with respect to the file type.

In this case, for example, when the final image data has a capacity of, for example, 3.5 MByte, the control unit 19 determines that the capacity of the final image data exceeds the specified capacity (3 MByte) (Step 9: No).

At that time, as shown in FIG. 9, the error message 60 including the information 61 and 62 is displayed on the capacity specifying and generation condition setting screen 40 (Step 13).

Besides, together with the error message 60, an instruction unit 63 to instruct re-specifying of the specified capacity and resetting of the setting conditions, and a completion unit 64 similar to the completion unit 45 are displayed on the capacity specifying and generation condition setting screen 40.

The control unit 19 determines whether the instruction unit 63 is touched by, for example, the user (Step 14). At Step 14, when the control unit 19 determines that the instruction unit 63 is not touched, it determines that the completion unit 64 is touched.

In the case where the control unit 19 determines that the instruction unit 63 is touched by the user (Step 14: Yes), the error message 60 disappears, the capacity specifying and generation condition setting screen 40 is again displayed (Step 15), and a return is made to Step 5. By this, the specified capacity for the final image data is again specified, and next, the generation conditions are again set as desired (Step 6).

Incidentally, at this time, the generation conditions and the initial values at the time when the final image data having the capacity exceeding the specified capacity is generated may be displayed on the capacity specifying and generation condition setting screen 40.

Besides, in the case where the control unit 19 determines that the completion unit 64 is touched by the user (Step 14: No), the final image data exceeding the specified capacity is stored in the storage destination specified by the storage destination specifying unit 31 at Step 3 (Step 16).

By this, the operation is ended.

Incidentally, at Step 12 and Step 16, the temporal image data stored in the first memory unit 11 at Step 2 is deleted from the first memory unit 11, and the final image data stored in the second memory unit 13 at Step 8 is deleted from the second memory unit 13.

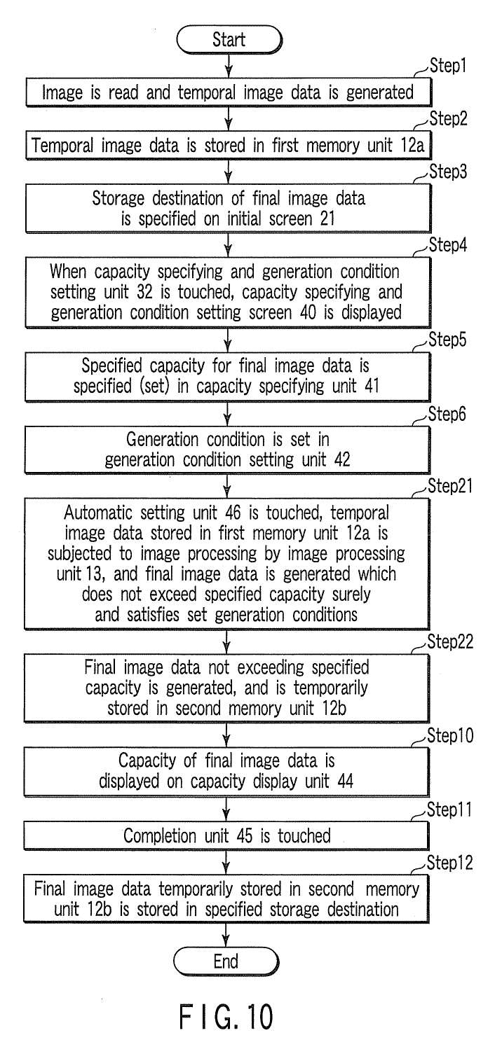

Next, in this embodiment, an operation method of generating final image data by automatic setting, and storing the final image data will be described with reference to FIG. 10.

In the automatic setting, the operation from Step 1 to Step 6 is substantially equal to the above. Thus, a detailed explanation thereof will be omitted.

After the specified capacity is specified at Step 5 and the generation conditions are set at Step 6, the automatic setting unit 46 is touched by the user. By this, the temporal image data stored in the first memory unit 11 is subjected to the image processing by the image processing unit 12 so as not to surely exceed the specified capacity and so as to satisfy the set generation conditions. Thus, the final image data which surely has the capacity not exceeding the specified capacity and satisfies the set generation conditions is generated (Step 21).

Particularly, the image processing unit 12 generates the final image data in JPEG based on the generation conditions set at Step 6, generates the final image data as color image data, and generates the final image data from the temporal image data including a small figure and a small character.

Besides, when the generation conditions are not set, the image processing unit 12 combines and adjusts, as desired, the items and numerical values of the generation conditions which are not set. Here, the generation conditions which are not set are the resolution, the compression ratio and the magnification ratio. The image processing unit 12 adjusts the combination of the numerical values of the resolution, the compression ratio and the magnification ratio, and generates the final image data having the capacity not exceeding the specified capacity. In the adjustment of the combination, the image processing unit 12 sets, for example, the resolution to “200” dpi, the compression ratio to “30%”, and the magnification ratio to “100%”. Alternatively, the image processing unit 12 sets, for example, the resolution to “300 dpi”, the compression ratio to “70%”, and the magnification ratio to “85%”. Incidentally, for example, in the case where the file type or the like is not set by the user, the image processing unit 12 adjusts also the file type, and performs the image processing.

As stated above, the image processing unit 12 changes the combination of the items and numerical values of the generation conditions which are not set, and repeats the image processing to make an adjustment so that the capacity of the final image data does not exceed the specified capacity.

By this, the final image data not exceeding the specified capacity is generated, and is temporarily stored in the second memory unit 13 (Step 22). Since the operation after this is substantially equal to Step 10 to Step 12, the details will be omitted.

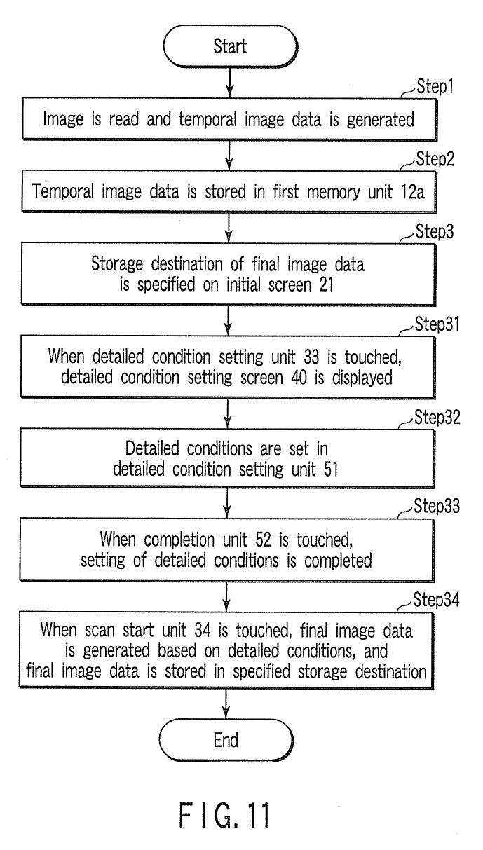

Next, in this embodiment, an operation method of generating final image data by detailed condition setting and storing the final image data will be described with reference to FIG. 11.

In the detailed condition setting operation, the operation from Step 1 to Step 3 is substantially equal to the above. Thus, a detailed explanation thereof will be omitted.

After Step 5, when the detailed condition setting unit 33 is touched by the user, the detailed condition setting screen 50 shown in FIG. 5 is displayed (Step 31).

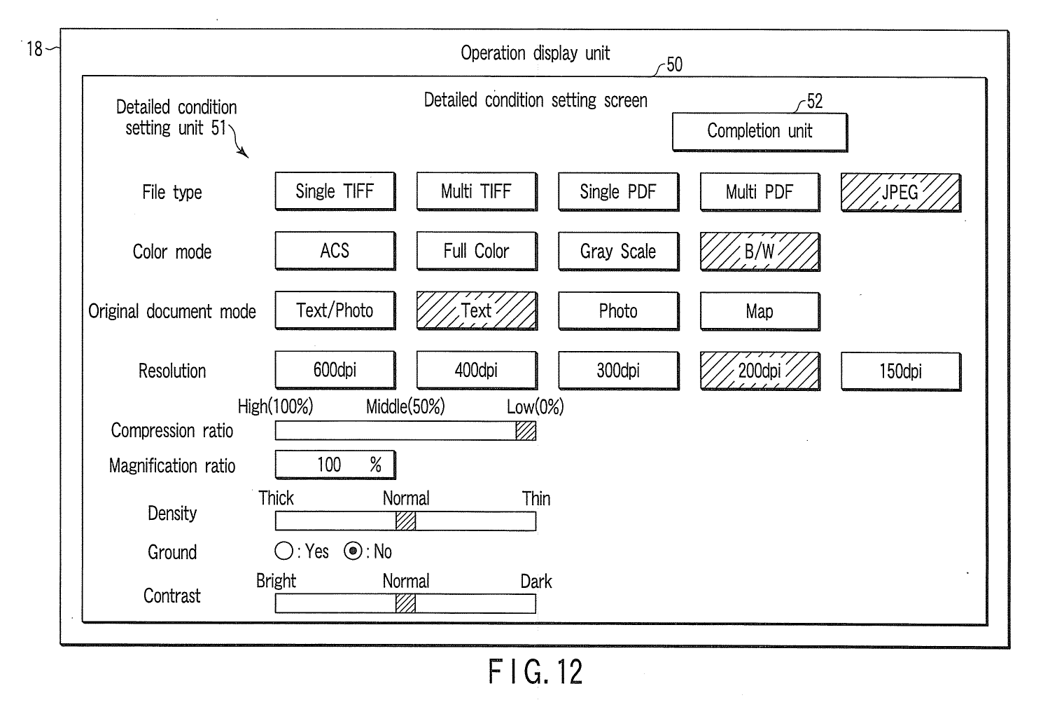

On the detailed condition setting screen 50, for example, as shown in FIG. 12, the detailed condition setting unit 51 is operated by the user, so that the detailed conditions are set (Step 32). Incidentally, in this detailed conditions, only items desired by the user are set. For example, as shown in FIG. 12, the user sets the file type to “JPEG”, the color mode to “B/W”, the original document mode to “Text”, and the resolution to “200 dpi”. The compression ratio, the magnification ratio, the density, the ground, and the contrast are not set by the user, and the state of the initial values is kept. That is, the compression ratio is set to “0%”, the magnification ratio is set to “100%”, the density is set to “normal”, the ground is set to “No”, and the contrast is set to “normal”.

The completion unit 52 is touched by the user, so that the setting of the detailed conditions is completed (Step 33). By this, the operation display unit is changed from the detailed condition setting screen 50 shown in FIG. 4 to the initial screen 21 shown in FIG. 2. When the scan start unit 34 is touched by the user, the final image data is generated by the image processing unit 12 from the temporal image data based on the detailed conditions, and the final image data is stored in the storage destination specified by the storage destination specifying unit 31 at Step 3 (Step 34).

Besides, at Step 34, the temporal image data stored in the first memory unit 11 at Step 2 is deleted from the first memory unit 11. By this, the operation is ended.

As stated above, in this embodiment, the image is once read by the read unit 10, the specified capacity for the image data is specified by the capacity specifying unit 41, and the generation conditions are merely set by the generation condition setting unit 42. By this, in this embodiment, the final image data having the capacity not exceeding the specified capacity can be generated, and can be stored.

In other words, in this embodiment, it is possible to prevent the final image data having the capacity exceeding the specified capacity from being generated. Besides, in this embodiment, like Step 9: No, even if the final image data having the capacity exceeding the specified capacity is generated, a return is made to Step 6, and therefore, it is possible to save the trouble of reading the image by the read unit 10 each time.

Besides, in this embodiment, like Step 9: No, even if the final image data exceeding the specified capacity is generated, like Steps 14, 15 and 6, the generation conditions and the specified capacity can be easily set again.

Besides, in this embodiment, like Step 10, since the capacity of the final image data can be displayed on the capacity display unit 44, the capacity of the final image data can be easily grasped.

Besides, in this embodiment, the final image data not exceeding the specified capacity can be generated. Thus, when the PC 17b is selected as the storage destination of the final image data by the E-mail transmission unit 31c, in this embodiment, the final image data is not divided, but is attached to an electronic mail or the like, and can be transmitted to the PC 17b by the transmission unit 17.

Besides, in the embodiment, by the operation method shown in FIG. 6, the user can generate the final image data not exceeding the specified capacity while adjusting the generation conditions as desired, and can store it. Besides, in this embodiment, by the operation method shown in FIG. 6, like Step 16, the final image data having the capacity not lower than the specified capacity can also be generated, and can be stored.

Besides, in the embodiment, the items and numerical values of the generation conditions which are not set by the automatic setting shown in FIG. 7 are combined and adjusted as desired, and the final image data having the capacity not exceeding the specified capacity is generated. Thus, in this embodiment, the final image data not exceeding specified capacity can be generated without fail, and can be stored.

Incidentally, in this embodiment, an adjustment may be made by, for example, the operation display unit 18 so that the initial values of the generation conditions and the detailed conditions are made identical to each other or different from each other. Besides, in this embodiment, the initial values of the generation conditions and the detailed conditions may be changed as desired by, for example, the operation display unit 18.

Incidentally, in this embodiment, as described with reference to FIGS. 6 and 7, the specified capacity is specified by the capacity specifying unit 41, and the desired generation conditions are set by the generation condition setting unit 42, however, it is not necessary to make a limitation to this. For example, the third memory unit 15 stores a previously set specified capacity and initial values of the generation conditions. When the capacity specifying and generation condition setting screen 40 is displayed, the image processing unit 12 in this embodiment performs the image processing based on the specified capacity previously stored in the third memory unit 15 and the initial values of the generation conditions, and generates the final image data.

By this, when the capacity of the final image data does not exceed the specified capacity, in this embodiment, it is possible to save the trouble of setting the specified capacity and the generation conditions, and the final image can be stored in a short time.

Besides, in this embodiment, as described with reference to FIG. 6, the operation method of specifying the specified capacity, setting the generation conditions, and generating and storing the final image data, and the operation method of generating the final image data based on the specified capacity previously stored in the third memory unit 15 and the initial values of the generation conditions and storing it may be selected. In this case, when the capacity specifying and generation condition setting screen 40 is displayed, either one of the operation methods may be selected. By this, in this embodiment, the capacity for the final image data can be set as desired.

Besides, in this embodiment, after the capacity of the final image data is displayed on the capacity display unit 44 at Step 10, a resetting unit to reset the specified capacity and the generation conditions may be displayed on the capacity specifying and generation condition setting screen 40. The resetting unit is touched by the user, so that a return can be made to Step 5. By this, in this embodiment, even in the case where the capacity of the final image data does not exceed the specified capacity, the specified capacity and the generation conditions can be set again, and more desirable final image data can be generated again and stored.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by appended claims and their equivalents.

What is claimed is:

1. An image forming apparatus comprising:
a read unit configured to read an image formed on a recording medium and to generate image data from the image;
a first memory unit configured to temporarily store the image data;
a capacity specifying unit configured to specify a capacity for final image data finally generated from the image data;
a generation condition setting unit configured to set a generation condition for generating the final image data;
an image processing unit configured to perform an image processing on the image data and to generate the final image data from the image data based on the generation condition;
a second memory unit configured to temporarily store the final image data generated by the image processing unit; and
a capacity display unit configured to display capacity of the final image data temporarily stored in the second memory unit.

2. The image forming apparatus according to claim 1, further comprising:
a storage destination specifying unit configured to specify a final storage destination of the final image data temporarily stored in the second memory unit; and
a storage unit configured to finally store the final image data when specified as the storage destination by the storage destination specifying unit.

3. The image forming apparatus according to claim 2, wherein a plurality of the storage units are provided.

4. The image forming apparatus according to claim 3, further comprising a transmission unit configured to transmit the final image data to the storage unit specified by the storage destination specifying unit.

5. The image forming apparatus according to claim 1, further comprising a calculation unit configured to calculate the capacity of the final image data when the final image data is generated.

6. The image forming apparatus according to claim 1, further comprising a third memory unit configured to store an initial value of the generation condition,
wherein the image processing unit generates the final image data based on the initial value when the generation condition is not set, and generates the final image data based on the set generation condition when the generation condition is set.

7. The image forming apparatus according to claim 6, wherein when the image processing unit generates the final image data based on the initial value, the generation condition setting unit serves also as a display unit to display the initial value.

8. The image forming apparatus according to claim 6, wherein when the image processing unit generates the final image data based on the generation condition, the generation condition setting unit serves also as a display unit to display the generation condition which is set when the final image data is generated.

9. The image forming apparatus according to claim 6, wherein when the image processing unit generates the final image data based on the generation condition and the initial value, the generation condition setting unit serves also as a display unit to display the generation condition which is set when the final image data is generated and the initial value.

10. The image forming apparatus according to claim 1, wherein the image processing unit generates the final image data having the capacity not exceeding the capacity specified by the capacity specifying unit.

11. The image forming apparatus according to claim 1, further comprising a display unit configured to display, when the capacity of the final image data exceeds the capacity specified by the capacity specifying unit, information to indicate that the capacity of the final image data exceeds the specified capacity and the capacity of the final image data.

12. The image forming apparatus according to claim 1, wherein when the generation condition is not set, the image processing unit combines and adjusts an item and a numerical value of the not-set generation condition as desired, and generates the final image data having the capacity not exceeding the capacity specified by the capacity specifying unit.

13. An image forming method comprising:
reading an image formed on a recording medium to generate image data from the image;
storing the image data temporarily;
specifying a capacity for final image data finally generated from the image data;
setting a generation condition for generating the final image data;
performing an image processing on the image data to generate the final image data from the image data based on the generation condition;
storing the generated final image data temporarily; and
displaying capacity of the temporarily stored final image data.

14. The image forming method according to claim 13, wherein
a final storage destination of the temporarily stored final image data is specified; and
the final image data is finally stored when the storage destination is specified.

15. The image forming method according to claim 14, wherein the final image data is transmitted to the specified storage destination.

16. The image forming method according to claim 13, wherein the capacity of the final image data is calculated when the final image data is generated.

17. The image forming method according to claim 13, wherein
an initial value of the generation condition is stored, and
the final image data is generated based on the initial value when the generation condition is not set, and the final image data is generated based on the set generation condition when the generation condition is set.

18. The image forming method according to claim 17, wherein when the final image data is generated based on the initial value, the initial value is displayed.

19. The image forming method according to claim 17, wherein when the final image data is generated based on the generation condition, the generation condition which is set when the final image data is generated is displayed.

20. The image forming method according to claim 17, wherein when the final image data is generated based on the generation condition and the initial value, the generation condition which is set when the final image data is generated and the initial value are displayed.

21. The image forming method according to claim 13, wherein the final image data having the capacity not exceeding the specified capacity is generated.

22. The image forming method according to claim 13, wherein when the capacity of the final image data exceeds the specified capacity, information to indicate that the capacity of the final image data exceeds the specified capacity and the capacity of the final image data are displayed.

23. The image forming method according to claim 13, wherein when the generation condition is not set, an item and a numerical value of the not-set generation condition are combined and adjusted as desired, and the final image data having the capacity not exceeding the specified capacity is generated.
